(19) United States
(12) Patent Application Publication
(10) Pub. No.: US 2024/0430611 A1
(43) Pub. Date: Dec. 26, 2024

(54) EARPHONES

(71) Applicant: SHENZHEN SHOKZ CO., LTD., Shenzhen (CN)

(72) Inventors: Yongjian LI, Shenzhen (CN); Shuailin XIE, Shenzhen (CN)

(73) Assignee: SHENZHEN SHOKZ CO., LTD., Shenzhen (CN)

(21) Appl. No.: 18/830,817

(22) Filed: Sep. 11, 2024

Related U.S. Application Data
(63) Continuation of application No. PCT/CN2022/120216, filed on Sep. 21, 2022.

(51) Int. Cl. H04R 1/10; H04R 5/033

(52) U.S. Cl. CPC H04R 1/105; H04R 1/1066; H04R 5/0335

(57) ABSTRACT

Disclosed is an earphone including one or more core modules, one or more ear hook components connected to the one or more core modules, and a rear hook component connected to the one or more ear hook components. Each of the one or more ear hook components is configured to hang on an ear of a user in a wearing state, the rear hook component is configured to bypass a rear side of a head of the user in the wearing state. The rear hook component includes an elastic metal tube and a wire threaded within the elastic metal tube. Compared with the related technology in which the rear hook component is an elastic covering wrapping an elastic metal wire and a wire, in the present disclosure, the elastic metal wire is changed into an elastic metal tube and the wire is threaded within the elastic metal tube.

### CROSS-REFERENCE TO RELATED APPLICATIONS

This application is a continuation of International Application No. PCT/CN2022/120216, filed on Sep. 21, 2022, the contents of which are entirely incorporated herein by reference.

### TECHNICAL FIELD

The present disclosure relates to the technical field of electronic devices, and in particular to an earphone.

### BACKGROUND

With the continuous popularization of electronic devices, the electronic devices become indispensable social and entertainment tools in people's daily lives, and people's requirements for the electronic devices are getting higher and higher. The electronic devices such as earphones are widely used in people's daily life, which can be used in conjunction with cell phones, computers, and other terminal equipment to facilitate a provision of auditory feast for users. According to a working principle of the earphones, the earphones may include an air conduction earphone and a bone conduction earphone. According to the manner the user wears the earphones, the earphones may include a headset earphone, an ear-hook earphone, and an in-ear earphone. According to the manner of interaction between the earphones and the electronic devices, the earphones may include a wired earphone and a wireless earphone. An inventor of the present disclosure has found in a long-term research that for the ear-hook earphone, whose rear hook bypasses a rear side of a head of the user and ear hook is hung on an ear of the user, if the weight of a portion of the earphone located on the rear side of the ear (e.g., the rear hook and most of the ear hook) is too great, there is a risk for the earphone to rotate around the highest point of the ear hook, which leads to the ear hook to press on the rear side of the ear, causing an uncomfortable wearing, and causing a core module to be far away from an entrance of an outer ear canal of the ear. In such cases, the hearing effect of the earphone may be degraded, e.g., a heard volume may be reduced.

### SUMMARY

Embodiments of the present disclosure provide an earphone. The earphone includes one or more core modules, one or more ear hook components connected to the one or more core modules, and a rear hook component connected to the one or more ear hook components. Each of the one or more ear hook components is configured to hang on an ear of a user under a wearing state. The rear hook component is used to bypass a rear side of a head of the user under the wearing state. The rear hook component includes an elastic metal tube and a wire threaded within the elastic metal tube.

Embodiments of the present disclosure provide an earphone. The earphone includes a support component and one or more core modules connected to the support component. The support component is configured to bypass a head of a user head and to support the one or more core modules and place the one or more core modules at a wearing position. The support component includes an elastic metal tube and a wire threaded within the elastic metal tube.

Beneficial effects of the present disclosure include: compared with the related technology where the rear hook component is an elastic metal wire and a wire wrapped by an elastic covering, the present disclosure changes the elastic metal wire into an elastic metal tube, and the wire is disposed in the elastic metal tube, which is conducive to reducing a weight of the rear hook component. Further, a center of gravity of the earphone is shifted, so that the earphone is farther away from a rear side of the head of the user in a sagittal axis direction of the user in the wearing state. In such cases, a risk of the earphone rotating around the highest point of the ear hook component in the wearing state is reduced, thus improving the stability and comfort of the earphone in wearing.

### BRIEF DESCRIPTION OF THE DRAWINGS

The present disclosure is further described in terms of exemplary embodiments. These exemplary embodiments are described in detail with reference to the drawings. Obviously, the drawings described below are only some embodiments of the present application. For those skilled in the art, other drawings can be obtained based on these drawings without creative work, wherein:

FIG. 1 is a schematic diagram illustrating a structure of an earphone according to some embodiment of the present disclosure;

FIG. 2 is a schematic diagram illustrating a disassembled structure of a rear hook component according to some embodiment of the present disclosure;

FIG. 3 is a schematic diagram illustrating a cross-sectional structure of the rear hook component in FIG. 2;

FIG. 4 is a schematic diagram illustrating a local structure of portion A in FIG. 2;

FIG. 5 is a schematic diagram illustrating a local structure of portion A in FIG. 2 viewed from another perspective;

FIG. 6 is a schematic diagram illustrating a structure of an earphone viewed in a direction of a coronal axis of a user in the wearing state according to some embodiment of the present disclosure;

FIG. 7 is a schematic diagram illustrating a cross-sectional structure of a rear hook component according to some embodiment of the present disclosure;

FIG. 8 is a schematic diagram illustrating a structure of an earphone viewed in a direction of a coronal axis of a user in the wearing state according to some embodiment of the present disclosure;

FIG. 9 is a schematic diagram illustrating a structure of the earphone in FIG. 8 viewed from another perspective;

FIG. 10 is a schematic diagram illustrating a cross-sectional structure of a core module according to some embodiment of the present disclosure;

(a) and (b) in FIG. 11 are schematic diagrams illustrating structures of an earphone viewed in a coronal axis direction of a user in the wearing state according to some embodiments of the present disclosure.

### DETAILED DESCRIPTION

The present disclosure is described in further detail below in connection with the accompanying drawings and embodiments. In particular, it is noted that the following embodiments are only used to illustrate the present disclosure, but do not limit the scope of the present disclosure. Similarly, the following embodiments are only part of the embodiments of the present disclosure rather than all of the embodiments, and all other embodiments obtained by those skilled in the art without creative labor fall within the scope of protection of the present disclosure.

References to “embodiments” in the present disclosure mean that particular features, structures, or characteristics described combining embodiments are included in at least one embodiment of the present disclosure. It is understood by those skilled in the art, both explicitly and implicitly, that the embodiments described in the present disclosure may be combined with other embodiments.

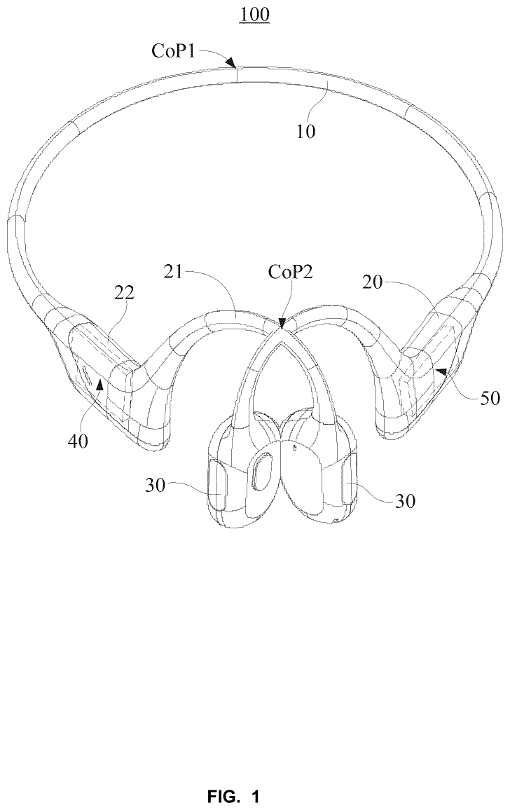

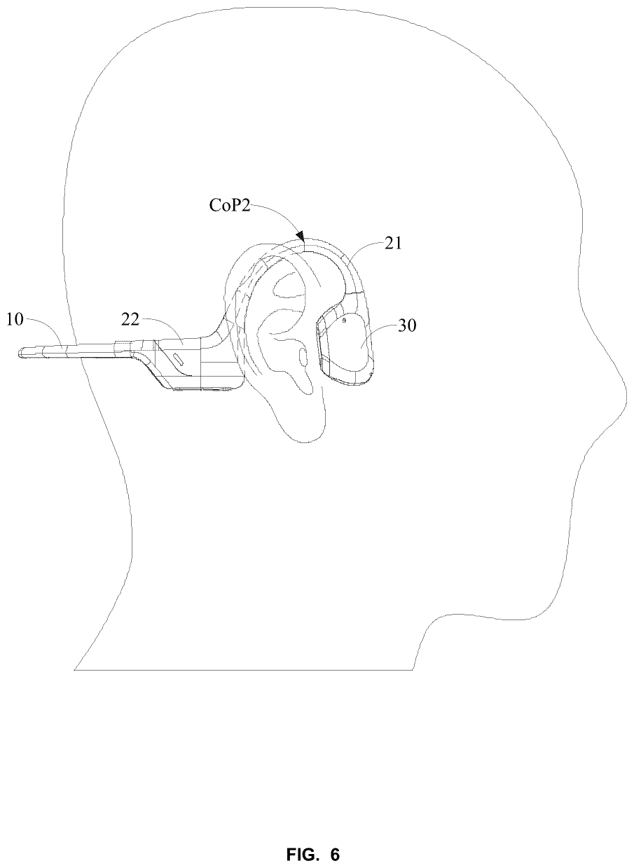

According to FIG. 1, the earphone 100 may include a rear hook component 10, one or more ear hook components 20 connected to the rear hook component 10, and one or more core modules 30 connected to the one or more ear hook components 20. The one or more core modules 30 are configured to convert an electrical signal into a mechanical vibration so as to facilitate a user to hear a sound through the earphone 100. Based on this, the rear hook component 10 is used to bypass a rear side of the head of the user in a wearing state, and each of the one or more ear hook components 20 is configured to hang on an ear of the user in the wearing state to support the one or more core modules 30 to be and place the one or more core modules 30 at a wearing position. According to FIG. 6, the foregoing wearing position may be a position on a cheek of the user near the ear; and according to (a) in FIG. 11, the foregoing wearing position may be a front side of the ear of the user away from the head.

It should be noted that a simulator including the head and (left and right) ears may be obtained based on ANSI: S3.36, S3.25 and IEC: 60318-7 standards, e.g. GRAS 45BC KEMAR. Thus, the “wearing state” described in the present disclosure may refer to not only the earphone 100 being worn by the user, but also to that the earphone 100 is worn on the simulator, thereby simulating the situation where the user wears the earphone 100 to facilitate related experiments. Of course, there are individual differences between different users, and the earphone 100 may be worn by different users in a manner that is different from the earphone 100 worn on the aforementioned simulator, which is not considered herein.

In some implementations, there may be two core modules 30, and the two core modules 30 are connected to two ends of the rear hook component 10 through an ear hook component 20. In such cases, each of the two core modules 30 converts the electrical signal into a core vibration to facilitate a stereo sound of the earphone 100. The earphone 100 may include a main board 40 disposed within one of the two ear hook components 20 and a battery 50 disposed within another one of the ear hook components 20. The main board 40 and the battery 50 may be coupled through a wire in the rear hook component 10. Correspondingly, the two core modules 30 may also be coupled to the main board 40 and the battery 50 through the wire in the ear hook components 20 and the rear hook component 10, which is exemplarily described later. In such cases, the two core modules 30, as well as the main board 40 and the battery 50, are respectively provided on both sides of the earphone 100 to equalize a weight distribution of the earphone 100, which is conducive to improving comfort and stability. In addition, at least one of the ear hook components 20 and the core modules 30 may be provided with function keys for realizing functions such as power on/off, play/pause, volume up, volume down, etc.

In some other embodiments where a requirement for the stereo sound is not particularly high, such as application scenarios such as hearing aids for a hearing patient and a live teleprompter for a host, there may be one core module 30. The core module 30 is disposed at one end of the rear hook component 10 and is connected to the rear hook component 10 through the corresponding ear hook component 20. The core module 30 that is originally disposed at the other end of the ear hook component 20 may be replaced with the main board 40 or the battery 50, or with an additional battery to enhance the battery life of the earphone 100. The core module 30 may also be replaced with a mass block of comparable size to the core module 30 for ease of wearing, which is likewise connected to the rear hook component 10 via the corresponding ear hook component 20.

For example, according to FIG. 1, the earphone 100 may include the rear hook component 10, two ear hook components 20, and two core modules 30. Two ends of the rear hook component 10 are respectively connected to one end of the corresponding ear hook component 20, and the other end of each of the two ear hook components 20 that is away from the rear hook component 10 is connected to a corresponding core module 30. The main board 40 and the battery 50 may be respectively disposed within the two ear hook components 20. For ease of description, each of the two ear hook components 20 may include an ear hook 21 and a compartment 22 connected to the ear hook 21. The ear hook 21 is configured to hang on the ear of the user in the wearing state, and the compartment 22 is configured to accommodate a member such as the main board 40 or the battery 50. One end of the ear hook 21 that is away from the compartment 22 is connected to the core module 30, and one end of the compartment 22 that is away from the ear hook 21 is connected to the rear hook component 10.

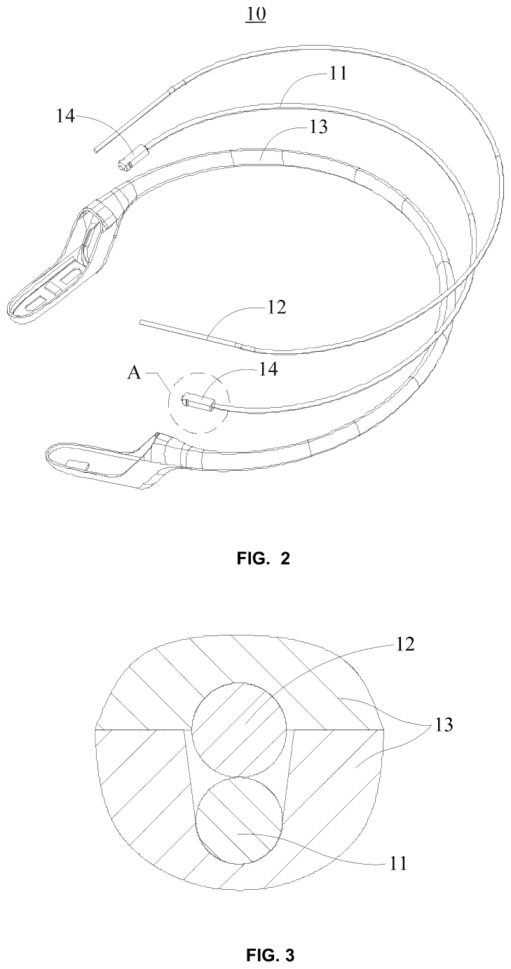

Further, according to FIG. 2 and FIG. 3, the rear hook component 10 may include an elastic metal wire 11, a wire 12, and an elastic covering 13. Each of the two ends of the elastic metal wire 11 is connected to one ear hook component 20. The wire 12 extends along the elastic metal wire 11 from one ear hook component 20 to the other ear hook component 20, and the elastic covering 13 wraps around the elastic metal wire 11 and the wire 12. In such cases, functional devices such as the core modules 30 on both sides of the earphone 100, the main board 40, and the battery 50 may be coupled via wire 12. A material of the elastic metal wire 11 may be any one of a nickel-titanium alloy, a spring steel, a stainless steel, etc. The material of the elastic covering 13 may be any one or a combination of a silicone gel, a thermoplastic urethane elastomer, a thermoplastic elastomer, etc.

It should be noted that the wire 12 may have a plurality of sub-wires insulated from each other to meet the wiring requirement of the earphone 100. Further, in addition to the elastic wires 11 and the wires 12, the elastic covering 13 may also wrap a portion of the ear hook component 20 to meet the design requirement of the earphone 100 in terms of appearance.

In some embodiments, the elastic covering 13 may be provided with a threading channel, and the elastic metal wire 11 and the wire 12 are threaded within the threading channel of the elastic covering 13. To facilitate threading, a size of the foregoing threading channel is configured to allow the elastic metal wires 11 and the wire wires 12 to move inside, for example, a cross-sectional area of the threading channel is greater than a sum of a cross-sectional area of the elastic metal wire 11 and a cross-sectional area of the wire 12.

In some other embodiments, the elastic covering 13 may be wrapped around the wire 12 by injection molding and include the threading channel, and the elastic metal wire 11 is threaded within the threading channel of the elastic covering 13. Similarly, to facilitate threading, the size of the threading channel is configured to allow the elastic metal wire 11 to move within the threading channel, e.g., the cross-sectional area of the threading channel is greater than the cross-sectional area of the elastic metal wire 11.

Further, to facilitate the connection between the rear hook component 10 and the ear hook component 20, according to FIG. 2, the rear hook component 10 may include connectors 14 sleeved on two ends of the elastic metal wire 11, and the rear hook component 10 is connected to the corresponding ear hook component 20 via the connectors 14. The connector 14 may be a plastic member molded on the elastic metal wire 11 by injection molding, or a metal member molded on the elastic metal wire 11 through die-casting or welding. In such cases, compared to flattening the end of the elastic metal wire 11 to connect the ear hook component 20, the connector 14 can reduce to a certain extent (or even eliminate) stress on the end of the elastic metal wire 11, which is conducive to lowering a risk of the end portion of the elastic metal wire 11 from breaking, thereby increasing reliability of the rear hook component 10.

It should be noted that: regardless of the molding process including the injection molding, the die casting, and the welding, to increase the bonding strength between the elastic metal wire 11 and the connector 14, a knurling structure may be disposed on an outer surface of the elastic metal wire 11 to increase a contact area between the elastic metal wire 11 and the connector 14. Further, according to FIG. 3, the end of the elastic metal wire 11 may be partially exposed from an outer end surface of the connector 14 that is away from an intermediate region of the elastic metal wire 11 to ensure the structural strength of the end of the rear hook component 10. When the connector 14 is connected to the elastic metal wire 11 by welding, a weld joint between the elastic metal wire 11 and the connector 14 is located between an exposed portion of the elastic metal wire 11 and the outer end surface of the connector 14, so as to facilitate shaping of the weld joint after welding, for example, to removing burrs.

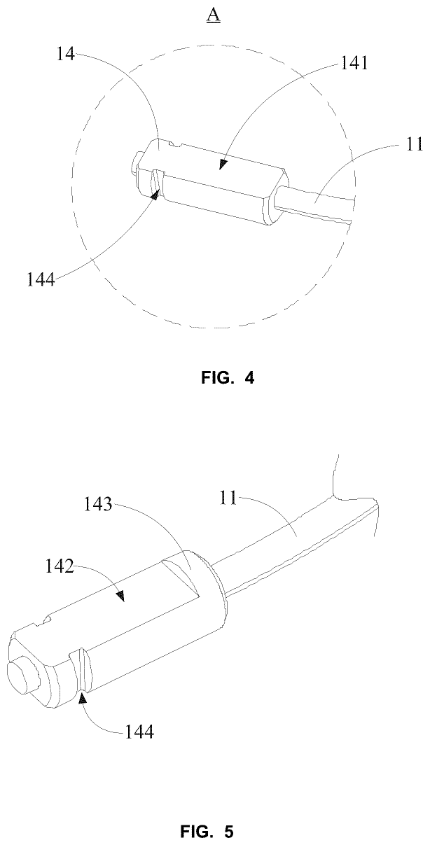

For example, according to FIG. 4 and FIG. 5, the connector 14 may have a columnar shape and may have a mounting surface 141 that is parallel to an axial direction of the connector 14. The mounting surface 141 may be disposed in a planar shape and penetrate both ends of the connector 14 along the axial direction of the connector 14. In other words, a portion of the connector 14 is trimmed to reduce a radial difference between a localized outer peripheral surface of the connector 14 and an outer peripheral surface of the elastic metal wire 11. In this way, as the wire 12 is generally a wire with a substantially circular cross-section, the connector 14 may be assembled with the wire 12 through the planar mounting surface 141, which may prevent the wire 12 from being lifted too high when passing over the connector 14, thereby controlling the radial size of the end of the rear hook component 10.

Further, the connector 14 may have an anti-rotation surface 142 parallel to the axial direction of the connector 14, and the anti-rotation surface 142 may be parallel to the mounting surface 141. In other words, another portion of the connector 14 is also trimmed to change the connector 14 from a columnar shape to a biased flat shape. In this way, after the rear hook component 10 is connected to the one or more ear hook components 20 via the connector 14, the rear hook component 10 and the one or more ear hook components 20 may not rotate relative to each other. The anti-rotation surface 142 may only penetrate one end of the connector 14 that is away from the intermediate region of the elastic metal wire 11 along the axial direction of the connector 14, so that the other end of the connector 14 faces the intermediate region of the elastic metal wire 11 include a stop flange 143 in connection with the anti-rotation surface 142. In other words, the mounting surface 141 may penetrate both ends of the connector 14 along the axial direction of the connector 14; and the anti-rotation surface 142 may only penetrate one end of the connector 14 along the axial direction of the connector 14. In this way, in the process of connecting the rear hook component 10 to the ear hook component 20 via the connector 14, the connector 14 may be limited by abutting the stop flange 143 against an end surface of the ear hook component 20, thereby effectively avoiding an over-insertion.

Further, one end of the connector 14 that is away from the intermediate region of the elastic metal wire 11 may be provided with one or more stop-cut slots 144. The stop-cut slot 144 may penetrate the mounting surface 141 and the anti-rotation surface 142 along one radial direction of the connector 14, and there may be two stop-cut slot 144 opposite to each other along another radial direction of the connector 14. In this way, after the rear hook component 10 is connected to the ear hook component 20 through the connector 14, a snap ring may be snapped into the stop cut slots 144 to form a snap connection between the connector 14 and the ear hook component 20, thereby avoiding separation of the rear hook component 10 from the ear hook component 20 after the two are assembled.

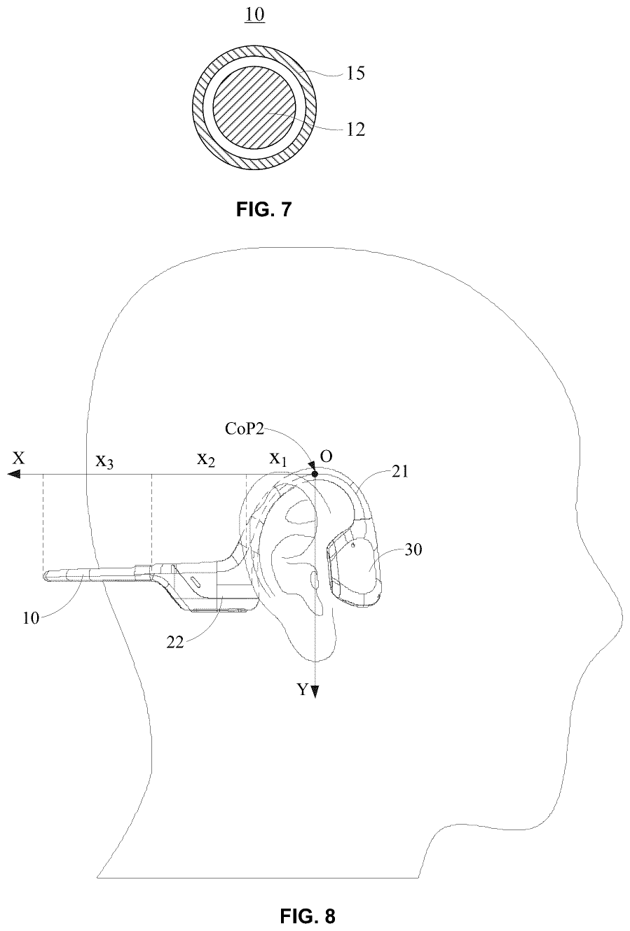

The inventors of the present disclosure have found in the course of their long-term research that: according to FIG. 6, in the wearing state, the rear hook component 10 bypasses the rear side of the head of the user, the ear hook component 20 is hang on the ear of the user, and the core module 30 is pressed against a cheek of the user near the ear. In such cases, if the weight of the portion of the earphone 100 located on the rear side of the ear (e.g., the rear hook component 10 and a great portion of the ear hook component 20) is too great, there is a risk that the earphone 100 rotates around the highest point of the ear hook component 20, causing the ear hook component 20 to press against the rear side of the ear and cause an uncomfortable wearing, and causing the core module 30 to move away from an entrance of an external ear canal of the ear, resulting in a deterioration in the listening effect, for example, a decrease in the heard volume. The highest point of the ear hook component 20 may be defined as a position of the ear hook component 20 that is closest to the top of the head of the user when the ear hook component 20 is in the wearing state and viewed in the direction of the coronal axis of the user (e.g., as shown by CoP2 in FIG. 6). To this end, according to FIG. 7, the present disclosure may improve the elastic metal wire 11 into an elastic metal tube 15, which is conducive to reducing the weight of the rear hook component 10, and thus reducing the risk of the earphone 100 rotating around the highest point of the ear hook component 20 in the wearing state. Further, in the present disclosure, the wire 12 may be threaded within the elastic metal tube 15, which is conducive to further lowering the weight of the rear hook component 10, because the elastic covering 13 was originally used to wrap the elastic metal wire 11 and wire 12 may also be omitted.

It should be noted that in the fields of medicine and anatomy, etc., three basic planes including a sagittal plane, a coronal plane, and a horizontal plane, as well as three basic axes including a sagittal axis, a coronal axis, and a vertical Axis, may be defined. The sagittal plane refers to a tangent plane perpendicular to a ground plane along an anterior-posterior direction of the body, which divides the human body into left and right portions; the coronal plane refers to a tangent plane perpendicular to the ground plane along a left-right direction of the human body, which divides the human body into front and rear portions; and the horizontal plane refers to a tangent plane parallel to the ground plane along an up-down direction of the human body, which divides the human body into upper and lower portions. Correspondingly, the sagittal axis refers to an axis that passes perpendicularly through the coronal plane along the anterior-posterior direction of the body, the coronal axis is the axis that passes perpendicularly through the sagittal plane along the left-right direction of the body, and the vertical axis refers to the axis that passes perpendicularly through the horizontal plane along the upper-lower direction of the human body.

It should be noted that, in the embodiment in which the wire 12 is threaded within the elastic metal tube 15, even if a covering layer such as a silicone, a thermoplastic urethane elastomer, and a thermoplastic elastomer, etc., is disposed to wrap the elastic metal tube 15, a thickness of the covering layer is less than a thickness of the elastic covering 13. This is because: the wire 12 is threaded within the elastic metal tube 15, and the covering layer wrapping the elastic metal tube 15 mainly serves functions of protection, decoration, and improvement of a hand feeling, etc.; whereas the elastic covering 13 wrapping the elastic metal wire 11 and the wire 12 not only serves the functions of protection, decoration, and improvement of the hand feeling, but also needs to have a sufficient structural strength to maintain a relative position relationship between the elastic metal wire 11 and the wire 12 to avoid the elastic metal wire 11 and the wire 12 from being separated from each other under action of an external force. Further, the covering layer may also be a coating molded onto the elastic metal tube 15 by spraying, drenching, etc., such as hand paint.

Similarly, to facilitate the connection between the elastic metal tube 15 and the ear hook component 20, the end portion of the elastic metal tube 15 may be sleeved with the connector 14. The relevant structure of the connector 14 and its connection manner with the ear hook component, etc. are the same as descriptions of FIGS. 2-12, which are not repeated herein.

For example, according to FIG. 1 and FIG. 7, two ends of the rear hook component 10 are connected to an ear hook component 20, respectively, and each of the ear hook components 20 is connected to one core module 30. That is, the earphone 100 includes two ear hook components 20 and two core modules 30, and the rear hook component 10 includes the elastic metal tube 15 and the wire 12 threaded within the elastic metal tube 15. Based on this, after the two core modules 30 are spread apart with a distance of 145 mm, there may be a clamping force of 0.3N to 0.6N. If the clamping force is too small, the mechanical vibration generated by the core module 30 may be less transmitted to the user; conversely, if the clamping force is too great, discomfort may be caused in wearing. Further, as the clamping force mainly originates from elastic deformation of the rear hook component 10, the rear hook component 10 may be removed from the earphone 100 and measured. In some embodiments, the rear hook component 10 may exert a clamping force of 0.3N to 0.6N after the two ends of the rear hook component 10 are spread apart by a distance of 110 mm.

It should be noted that the clamping force described in the present disclosure may be measured using an earphone clamping force tester (equipment manufacturer: Bowen Instruments, equipment model: FL-86161A). Specifically, to measure the clamping force, the earphone 100 is clamped on both sides of parallel plates of the clamping force tester. Further, the parallel plates of the clamping force tester cause the two core modules 30 to be separated from each other and have a test distance (e.g., an average of 145 mm for a human head width), which simulates a scenario in which the user wears the earphone 100. At this point, the clamping force may be obtained by reading a value displayed on the clamping force tester.

Further, the elastic deformation of the rear hook component 10 mainly originates from the elastic deformation of the elastic metal tube 15, and the elastic deformation capacity of the elastic metal tube 15 is mainly dependent on parameters such as a material, a length, a bending degree, an inner diameter, an outer diameter, etc. An elastic modulus of the elastic metal tube 15 may be between 60 GPa and 100 GPa. The material of the elastic metal tube 15 may be any one of a nickel-titanium alloy, a spring steel, a stainless steel, etc. As the elastic metal tube 15 bypasses the rear side of the head of the user in the wearing state, the length and the bending degree thereof can be determined correspondingly, for example, the length of the elastic metal tube 15 is between 180 mm and 220 mm. As the configuration of the elastic metal tube 15 needs to consider the weight of the rear hook component 10, the requirements of threading the wires 12 and providing a clamping force, the inner diameter of the elastic metal tube 15 may be between 0.8 mm and 1.5 mm. A wall thickness of the elastic metal tube 15 may be between 0.05 mm and 0.3 mm.

In the following, an exemplary illustration of the relevant test is provided, for example, a nickel-titanium alloy with an elastic modulus of about 84 GPa and a density of 6.45-6.48 g/cm³ is made into an elastic metal wire 11 with a length of 200 mm and a diameter of 1.15 mm, and elastic metal tubes 15 with a length of 200 mm and different combinations of inner and outer diameters. The bending degrees of these samples (the elastic metal wire 11 and the elastic metal tubes 15) are the same. Two ends of the elastic metal wire 11 or each of the elastic metal tubes 15 are pulled apart with an external force of 1 N, the corresponding displacements are recorded, and the test results are shown in Table 1 below.

TABLE 1

| | Inner | Outer | Wall | | |
|---|---|---|---|---|---|
| | diameter/mm | diameter/mm | thickness/mm | Volume/mm³ | Displacement/mm |
| Elastic | / | | | 1.04 | 36.3 |
| wire | | | | | |
| Elastic | 1.5 | 1.64 | 0.07 | 0.35 | 29.9 |
| metal | | 1.62 | 0.06 | 0.29 | 36.3 |
| tubes | 1.2 | 1.6 | 0.2 | 0.88 | 14.2 |
| | | 1.4 | 0.1 | 0.41 | 36.1 |
| | 1 | 1.3 | 0.15 | 0.54 | 34.3 |
| | | 1.29 | 0.145 | 0.52 | 36 |
| | 0.9 | 1.26 | 0.18 | 0.61 | 34.1 |
| | | 1.24 | 0.17 | 0.57 | 37.2 |
| | 0.8 | 1.21 | 0.205 | 0.65 | 36.3 |
| | | 1.2 | 0.2 | 0.63 | 38.2 |

According to Table 1, for the elastic metal wire 11 and the elastic metal tube 15 of the same material, the same length, and the same bending degree, when pulled apart by the same external force for the same displacement, that is, when the elastic metal tube 15 and the elastic metal wire 11 provide the same clamping force, the weight of the elastic metal tube 15 may be reduced by at least 40% compared to the weight of the elastic metal wire 11. Based on this, when the elastic metal wire 11 is changed into the elastic metal tube 15 such that the weight of the rear hook component 10 becomes smaller and the elastic covering 13 is omitted, the weight of the rear hook component 10 may be further reduced, and a center of gravity of the earphone is shifted so that the center of gravity is farther away from the rear side of the head of the user in the direction of the sagittal axis of the human body in the wearing state, which is conducive to reducing the risk of the earphone 100 rotating around the highest point of the ear hook component 20 in the wearing state.

For example, the mass of the rear hook component 10 may be between 1 g and 3 g, and the length of the rear hook component 10 may be between 150 mm and 250 mm.

In some embodiments, according to FIGS. 1, 7, and 8, after the rear hook component 10 is cut off at a first cut-off position and the ear hook component 20 is cut off at a second cut-off position, on a reference plane where the sagittal axis of the human body is located (e.g., the plane where the paper surface in FIG. 8 is located), a first portion of the rear hook component 10 and the ear hook component 20 that remains connected to each other between the first and second cut-off positions may have a torque in a range of 30 gf·cm and 60 gf·cm. The first cut-off position may be defined as a position at half the length of the rear hook component 10 (e.g., shown as CoP1 in FIG. 1), and the second cut-off position may be defined as a position of the ear hook component 20 that is closest to a top of a head of the user when the ear hook component is in the wearing state and viewed in a coronal axis direction of the user (e.g., shown as CoP2 in FIG. 1 and FIG. 8).

Further, the torque (denoted as M) may be determined according to the following equation:

$$M = {G}_{1} \cdot \frac{{X}_{1}}{2} + {G}_{2} \cdot ( {X}_{1} + \frac{{X}_{2}}{2} ) + {G}_{3} \cdot ( {X}_{1} + {X}_{2} + \frac{{X}_{3}}{2} ) ,$$

where G1, G2, and G3 respectively denote the weight of the ear hook 21, the compartment 22, and the rear hook component 10 in the first portion. The weight of the compartment 22 includes the weights of structural members, such as the main board 40 or the battery 50 accommodated therein. Further, an XOY coordinate system is established on the reference plane where the sagittal plane of the user is located, with an origin O being the second cut-off position, an X-axis parallel to an extension direction of the compartment 22 or the extension direction of the rear hook component 10 in the first portion, and a Y-axis perpendicular to the X-axis. X₁, X₂, and X₃ respectively represents projections of the lengths of the ear hook 21, the compartment 22, and the rear hook component 10 in the first portion on the X-axis. Based on this, in the wearing state, a photograph of both the earphone 100 and a straightedge is taken along the coronal axis of the user; then the actual size corresponding to 1 cm of the straightedge in the photograph is measured to determine a scaling ratio An XOY coordinate system is established in the photograph in the abovementioned manner, the projections of the lengths of the ear hook 21, the compartment 22, and the rear hook component 10 in the first portion are obtained, the projections are scaled according to the above scaling ratio to obtain X₁, X₂, and X₃. Further, the rear hook component 10 is cut off at the first cut-off position, the ear hook component 20 is cut off at the second cut-off position, and the compartment 22 is disassembled from the rear hook component 10 and the ear hook 21, respectively (the three are generally connected through a plug-in connection). Then the weights of the disassembled ear hook 21, the compartment 22, and the rear hook component 10 in the first portion are measured respectively to obtain G₁, G₂, and G₃.

In some embodiments, according to FIG. 1, FIG. 7, and FIG. 8, after the rear hook component 10 is cut off at the first cut-off position and the ear hook component 20 is cut off at the second cut-off position, a mass of the first portion of the rear hook component and the ear hook components connected to each other between the first cut-off position and the second cut-off position is between 2 g and 15 g. The first cut-off position may be defined as a position at half the length of the rear hook component 10 (e.g., shown as CoP1 in FIG. 1), and the second cut-off position may be defined as a position of the ear hook component 20 that is closest to a top of a head of the user when the ear hook component 20 is in the wearing state and viewed in a coronal axis direction of the user (e.g., shown as CoP2 in FIG. 1 and FIG. 8).

An exemplary illustration of the relevant test is provided below, e.g., a main difference between Example #1 and Example #2 is that Example #1 is the elastic metal wire 11 (as well as the wire 12, the elastic covering 13, and the connector 14) whereas Example #2 is the elastic metal tube 15 (as well as the wire 12 and the connector 14), and the relevant results of the test are shown in Table 2 below.

TABLE 2

| Example | G1/(×10⁻³N) | G2/(×10⁻³N) | G3/(×10⁻³N) | ×1/mm | ×2/mm | ×3/mm | M/(×10⁻³N · m) |
|---|---|---|---|---|---|---|---|
| #1 | 5.64 | 46.5 | 37.09 | 20 | 30 | 50 | 4.47 |
| #2 | | | 10.29 | | | | 2.46 |

According to Table 2, when the elastic metal wire 11 is changed into the elastic metal tube 15, the mass of the first portion is significantly reduced. With the omission of the elastic covering 13, the mass of the first portion is further significantly reduced, and the torque of the earphone 100 in the wearing state relative to the highest point of the ear hook component 20 is also significantly reduced, which is conducive to reducing the risk of the earphone 100 rotating around the highest point of the ear hook component 20 in the wearing state.

In some embodiments, according to FIG. 1 and FIG. 7, after the rear hook component 10 is cut off at the first cut-off position and the ear hook component 20 is cut off at the second cut-off position, a distance between the second cut-off position and the center of gravity of the first portion of the rear hook component 10 and the ear hook component 20 connected to each other between the first cut-off position and the second cut-off position may be less than or equal to 30 mm. The first cut-off position may be defined as the position at half the length of the rear hook component 10 (e.g., shown as CoP1 in FIG. 1), and the second cut-off position may be defined as the position closest to the top of the head of the user when the ear hook component 20 is the wearing state and viewed in the direction along the coronal axis of the user (e.g., shown as CoP2 in FIG. 1).

It should be noted that the center of gravity as described in the present disclosure refers to a point where the resultant force of the earth's gravity on each tiny portion of the object acts. Therefore, in this embodiment, a plumb line may be used to find the center of gravity of an object (e.g., the first portion).

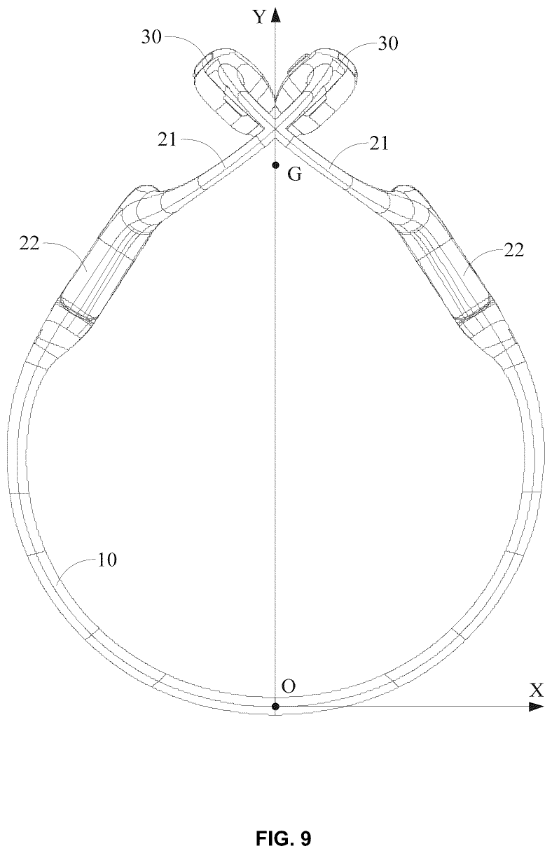

In some embodiments, according to FIGS. 1, 7, and 9, the earphone 100 is orthogonally projected onto a reference plane (e.g., the plane where the paper surface is located in FIG. 9) where the elastic metal tube 15 is located, and a first reference axis (e.g., shown as Y in FIG. 9) and a second reference axis (e.g., shown as X in FIG. 9) orthogonal to each other are established. The elastic metal tube 15 is symmetrical about the first reference axis, and a reference intersection point of the first reference axis and the second reference axis (e.g., shown as O in FIG. 9) is located in the center of the elastic metal tube 15. Based on this, a distance between the center of gravity of the earphone 100 (e.g., shown as G in FIG. 9) and the reference intersection point in the first reference axis may be between 60 mm and 110 mm.

It should be noted that the center of gravity in the present disclosure refers to the point where the resultant force of the earth's gravity on each tiny portion of the object acts, so in addition to finding the center of gravity of an object (e.g., the first portion) using the plumb line, in some embodiments, the center of gravity of the headset 100 may also be analyzed and determined using 3D software such as Creo. For example: 1) scan and obtain appearance parameters of any earphone 100, and perform a 3D solid modeling of the earphone 100 using Creo based on the appearance parameters to obtain a 3D model of the earphone 100; 2) analyze volumes of the rear hook component 10, the ear hook 21, the compartment 22, and the core module 30 in the 3D model using Creo; 3) obtain masses of the rear hook component 10, the ear hook 21, the compartment 22, and the core module 30 in the earphone 100. The rear hook component 10, the ear hook component 20, and the core module 30 of the earphone 100 are generally connected through a plug connection, and the ear hook 21 and the compartment 22 in the ear hook component 20 are generally integrally formed through a metal insert process. Regardless of how these components are connected, the corresponding manners are used to destroy the connection between them, and the disassembled components are weighed to obtain the corresponding masses; 4) Assume that the weights of the rear hook component 10, the ear hook 21, the compartment 22, and the core module 30 in the earphone 100 are uniformly distributed, which is actually close to being uniformly distributed, and determine the densities of the rear hook component 10, the ear hook 21, the compartment 22, and the core module 30 using the volumes obtained in 2) and the masses obtained in 3); 5) respectively assign the densities obtained in 4) to the rear hook component 10, the ear hook 21, the compartment 22 and the core module 30; 6) define a coordinate system in Creo, the XOY plane in the coordinate system passes the plane where the elastic metal tube 15 is located, the YOZ plane of the coordinate system is an asymmetry plane of the elastic metal tube 15, and the original point O of the coordinate system is a center of the elastic metal tube 15 (i.e., a position at half the length of the elastic metal tube 15); 7) analyze the center of gravity of the earphone 100 in the XOY, YOZ and XOZ planes, respectively using Creo, and the center of gravity of the earphone 100 in the XOY plane is mainly studied.

An exemplary illustration of the relevant test is provided below, e.g., the main difference between Example #3 and Example #4 is that Example #3 is the elastic metal wire 11 (as well as the wire 12, the elastic covering 13, and the connector 14) whereas Example #4 is the elastic metal tube 15 (as well as the wire 12 and the connector 14), and the relevant results of the test are shown in Table 3 below.

TABLE 3

| | Core | Ear | Compartment | Compartment | Rear hook | |
|---|---|---|---|---|---|---|
| | module | hook | 1 | 2 | component | |
| Example | #3, #4 | #3, #4 | #3, #4 | #3, #4 | #3 | #4 |
| Mass/g | 6.125 | 1.15 | 4.32 | 5.17 | 6.785 | 1.05 |
| Volume/cm³ | 3.282 | 0.622 | 3.498 | | 2.049 | |
| Density/(g/cm³) | 1.894 | 1.849 | 1.235 | 1.478 | 1.847 | 0.512 |

| Example | Distance between the center of gravity and the reference intersection |
|---|---|
| | point in the first reference axis/mm |
| #3 | 96 |
| #4 | 103 |

The compartment 1 is a compartment 22 in the earphone 100 for accommodating structural members such as the main board 40, and the compartment 2 is a compartment 22 in the earphone 100 for accommodating structural members such as the battery 50.

According to Table 3, after the elastic metal wire 11 is changed into the elastic metal tube 15, the weight of the rear hook component 10 becomes smaller. Further, after omitting the elastic covering 13, the weight of the rear hook component 10 is further reduced, and the center of gravity of the earphone 100 is shifted so that the earphone 100 is farther away from the rear side of the head of the user in the sagittal axis direction of the user in the wearing state, which is conducive to reducing the risk of the earphone 100 rotating around the highest point of the ear hook component 20 in the wearing state.

For example, according to FIG. 7, the elastic metal tube 15 may be closed in its radial direction and may be of equal diameter, for example, the elastic metal tube 15 may have a circular or a square ring cross-section.

For example, the elastic metal tube 15 may have an open structure in its radial direction, for example, the elastic metal tube 15 has a U-shape or a C-shape cross-section.

For example, the elastic metal tube 15 may be a non-equal diameter structure and have a long axis direction and a short axis direction perpendicular to the length direction of the elastic metal tube 15 and orthogonal to each other, and the size of the elastic metal tube 15 in the long axis direction is greater than the elastic metal tube 15 in the short-axis direction. For example, the elastic metal tube 15 has a cross-section of an oval or rectangular ring. In the wearing state, the short-axis direction of the elastic metal tube 15 points to the head of the user.

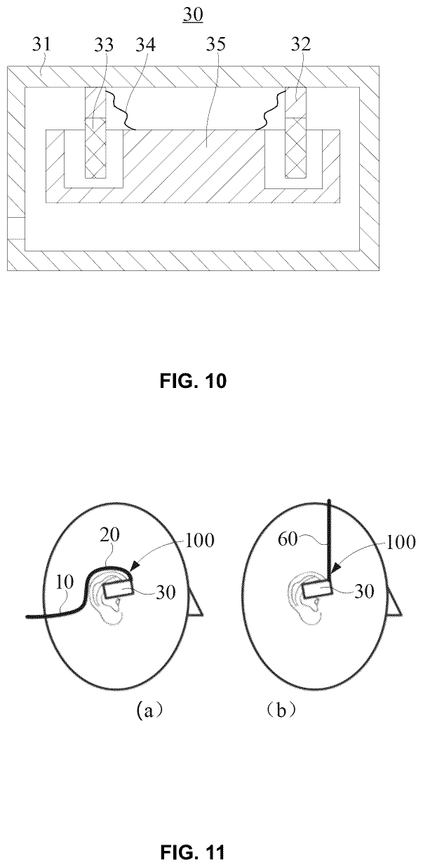

For example, according to FIG. 10, the core module 30 may include a core housing 31 connected to the ear hook component 20, as well as a support 32, a coil 33, a vibration transmission plate 34, and a magnetic circuit system 35 disposed in the core housing 31. The support 32 is fixed on the core housing 31; the coil 33 is wound on the support 32 and extends into a magnetic gap of the magnetic circuit system 35; an edge region of the vibration transmission plate 34 is connected to the support 32, for example, the vibration transmission plate 34 and the support 32 are integrally formed through a metal insert process; the magnetic circuit system 35 is used to form a magnetic field and is connected to a center region of the vibration transmission plate 34. In such cases, the magnetic field generated when the coil 33 is energized interacts with the magnetic field formed by the magnetic circuit system 35 to convert an electrical signal into a mechanical vibration. The core housing 31 may be in contact with the skin of the user such that the core module 30 may transmit the mechanical vibration primarily by bone conduction, which generates a bone conduction sound.

For example, according to FIG. 11, the earphone 100 may include a support component 60 and a core module 30 connected to the support component 60. The support component 60 is configured to bypass the head of the user and support the core module 30 and place the core module 30 at a wearing position. The support component 60 may include the rear hook component 10 that bypasses the rear side of the head of the user in the wearing state and the ear hook component 20 that hangs on the ear of the user in the wearing state; the support component 60 may also include a headband component that bypasses a top of the head of the user in the wearing state. Similarly, the support component 60 may include the elastic metal tube 15 and the wire 12 threaded within the elastic metal tube 15. The structure of the elastic metal tube 15 is the same or similar to that described in FIGS. 7 to 11, which is not repeated herein.

The foregoing is only a portion of the embodiments of the present disclosure, and is not intended to limit the scope of protection of the present disclosure, and any equivalent device or equivalent process transformations utilizing the contents of the contents of the present disclosure and the accompanying drawings, or applying them directly or indirectly in other related technical fields, are similarly included in the scope of patent protection of the present disclosure.

What is claimed is:

1. An earphone including one or more core modules, one or more ear hook components connected to the one or more core modules, and a rear hook component connected to the one or more ear hook components, wherein
each of the one or more ear hook components is configured to hang on an ear of a user in a wearing state, and
the rear hook component is configured to bypass a rear side of a head of the user in a wearing state, wherein the rear hook component includes an elastic metal tube and a wire threaded within the elastic metal tube.

2. The earphone of claim 1, wherein
the one or more core modules include two core modules, the one or more ear hook components include two ear hook components,
two ends of the rear hook component are connected to one of the two ear hook components, respectively, and each of the two ear hook components is connected to one of the two core modules, wherein
the two core modules exert a clamping force of 0.3 N to 0.6 N after being spread apart by a distance of 145 mm.

3. The earphone of claim 2, wherein the two ends of the rear hook component exert a clamping force of 0.3N to 0.6N after being spread apart by a distance of 110 mm.

4. The earphone of claim 3, wherein an inner diameter of the elastic metal tube is between 0.8 mm and 1.5 mm.

5. The earphone of claim 4, wherein a wall thickness of the elastic metal tube is between 0.05 mm and 0.3 mm.

6. The earphone of claim 3, wherein an elastic modulus of the elastic metal tube is between 60 GPa and 100 GPa.

7. The earphone of claim 2, wherein the earphone includes a main board disposed within one of the two ear hook components and a battery disposed within another one of the two ear hook components, and the main board and the battery are coupled through the wire.

8. The earphone of claim 1, wherein when the rear hook component is cut off at a first cut-off position and one of the one or more ear hook components is cut off at a second cut-off position, on a reference plane where a sagittal plane of the user is located, a torque of a first portion of the rear hook component and the ear hook component connected to each other between the first cut-off position and the second cut-off position relative to the second cut-off position is between 30 gf·cm and 60 gf·cm, wherein
the first cut-off position is defined as a position at half a length of the rear hook component, and the second cut-off position is defined as a position of the ear hook component that is closest to a top of the head of the user when the ear hook component is in the wearing state and viewed in a coronal axis direction of the user.

9. The earphone of claim 1, wherein when the rear hook component is cut off at a first cut-off position and one of the one or more ear hook components is cut off at a second cut-off position, a distance from the second cut-off position to a center of gravity of a first portion of the rear hook component and the ear hook components connected to each other between the first cut-off position and the second cut-off position is less than or equal to 30 mm, wherein
the first cut-off position is defined as a position at half a length of the rear hook component, and the second cut-off position is defined as a position of the ear hook component that is closest to a top of the head of the user when the ear hook component is in the wearing state and viewed in a coronal axis direction of the user.

10. The earphone of claim 1, wherein when the rear hook component is cut off at a first cut-off position and one of the one or more ear hook components is cut off at a second cut-off position, a mass of a first portion of the rear hook component and the ear hook components connected to each other between the first cut-off position and the second cut-off position is between 2 g and 15 g, wherein
the first cut-off position is defined as a position at half a length of the rear hook component, and the second cut-off position is defined as a position of the ear hook component that is closest to a top of the head of the user when the ear hook component is in the wearing state and viewed in a coronal axis direction of the user.

11. The earphone of claim 1, wherein when the earphone is orthogonally projected onto a reference plane where the elastic metal tube is located, and a first reference axis and a second reference axis orthogonal to each other are established, the elastic metal tube being symmetrical about the first reference axis, a reference intersection point where the second reference axis intersects with the first reference axis being located at a center of the elastic metal tube, a distance between a center of gravity of the earphone and the reference intersection point in a direction of the first reference axis is between 60 mm and 110 mm.

12. The earphone of claim 1, wherein a mass of the rear hook component is between 1 g and 3 g, and a length of the rear hook component is between 150 mm and 250 mm.

13. The earphone of claim 1, wherein the elastic metal tube has an open structure in a radial direction.

14. The earphone of claim 1, wherein the elastic metal tube has a non-uniform diameter structure and has a long axis direction and a short axis direction perpendicular to a length direction of the elastic metal tube, the long axis direction and the short axis direction are orthogonal to each other, a size of the elastic metal tube in the long axis direction is greater than a size of the elastic metal tube in the short axis direction, wherein
in the wearing state, the short axis direction points to the head of the user.

15. The earphone of claim 1, wherein the rear hook component includes one or more connectors sleeved on one or more ends of the elastic metal tube, and the rear hook component is connected to the one or more ear hook components through the one or more connectors.

16. The earphone of claim 15, wherein the one or more connectors are metal members and are connected to the elastic metal tube through die-casting or welding.

17. The earphone of claim 15, wherein each of the one or more connectors has a columnar shape and includes a mounting surface parallel to an axial direction of the connector.

18. The earphone of claim 17, wherein the connector includes an anti-rotation surface parallel to the axial direction of the connector, and the anti-rotation surface is parallel to the mounting surface.

19. The earphone of claim 18, wherein the anti-rotation surface penetrates one end of the connector that is away from an intermediate region of the elastic metal tube along the axial direction of the connector, and the other end of the connector facing the intermediate region of the elastic metal tube includes a stop flange in connection with the anti-rotation surface.

20. An earphone, including a support component and one or more core modules connected to the support component, wherein
the support component is configured to bypass a head of a user and support the one or more core modules and place the one or more core modules at a wearing position, wherein the support component includes an elastic metal tube and a wire threaded within the elastic metal tube.
